(19) United States
(12) Patent Application Publication
(10) Pub. No.: US 2016/0033713 A1
(43) Pub. Date: Feb. 4, 2016

(54) Backlight Assembly with Brightness Enhancing Arrangement

(71) Applicant: Szu-Wei Sun, Pingzhen City (TW)

(72) Inventor: Szu-Wei Sun, Pingzhen City (TW)

(21) Appl. No.: 14/513,250

(22) Filed: Oct. 14, 2014

(30) Foreign Application Priority Data
Jul. 29, 2014 (TW) 103213402

(51) Int. Cl. F21V 8/00

(52) U.S. Cl. CPC G02B 6/0055; G02B 6/0031; G02B 6/0021; G02B 6/0083

(57) ABSTRACT

A backlight assembly is provided with an upper reflective layer including a plurality of first openings; a lower reflective layer secured to the upper reflective layer; a light guide plate disposed between the upper and lower reflective layers; an opaque shading layer disposed on the upper reflective layer and including a circuit and a plurality of second openings; and a light source disposed under the lower reflective layer. The first openings are aligned with the second openings and communicate therewith. Light with enhanced brightness is transmitted to bottom of keycaps of an input device of a 3C product with energy consumed to a minimum during light transmitting.

### BACKGROUND OF THE INVENTION

1. Field of the Invention

The invention relates to backlight assembly and more particularly to a backlight assembly having a brightness enhancing arrangement so that light with enhanced brightness is transmitted to predetermined positions (i.e., bottom of keycap of a keyboard or keypad) of a 3C (computer, communication, and consumer electronics) product with energy consumed to a minimum during light transmitting.

2. Description of Related Art

Backlight is widely used in many electronic products and lights such as keyboards, keypads, notebook computers, mobile phones, remote control and displays. A conventional backlight assembly is comprised of a light guide layer, a reflector plate, a light shading plate and circuit board. The plates are manufactured separately prior to stacking in the manufacturing process. However, energy of the light may be lost gradually as it passes through multi-structure consisting of the light guide plate, the reflector plate, the light shading plate and the circuit board. As such, insufficient light is transmitted to predetermined positions (i.e., bottoms of keycap of a keyboard or keypad) of a 3C product. As a result, backlight efficiency is greatly decreased.

Thus, the need for improvement still exists.

### SUMMARY OF THE INVENTION

It is therefore one object of the invention to provide a backlight assembly comprising an upper reflective layer including a plurality of first openings; a lower reflective layer secured to the upper reflective layer; a light guide plate disposed between the upper and lower reflective layers; an opaque shading layer disposed on the upper reflective layer and including a circuit and a plurality of second openings; and a light source disposed under the lower reflective layer;. wherein the first openings are aligned with the second openings and communicate therewith.

The above and other objects, features and advantages of the invention will become apparent from the following detailed description taken with the accompanying drawings.

### BRIEF DESCRIPTION OF THE DRAWINGS

FIG. 1 is an exploded view of a backlight assembly according to a first preferred embodiment of the invention;

FIG. 2 is a longitudinal sectional view of the backlight assembly of FIG. 1;

FIG. 3 is a longitudinal sectional view of the assembled backlight assembly of FIG. 1;

FIG. 4 is an exploded view of a backlight assembly according to a second preferred embodiment of the invention;

FIG. 5 is a longitudinal sectional view of the assembled backlight assembly of FIG. 4;

FIG. 6 is a longitudinal sectional view of a backlight assembly according to a third preferred embodiment of the invention; and

FIG. 7 is a longitudinal sectional view of a backlight assembly according to a fourth preferred embodiment of the invention.

### DETAILED DESCRIPTION OF THE INVENTION

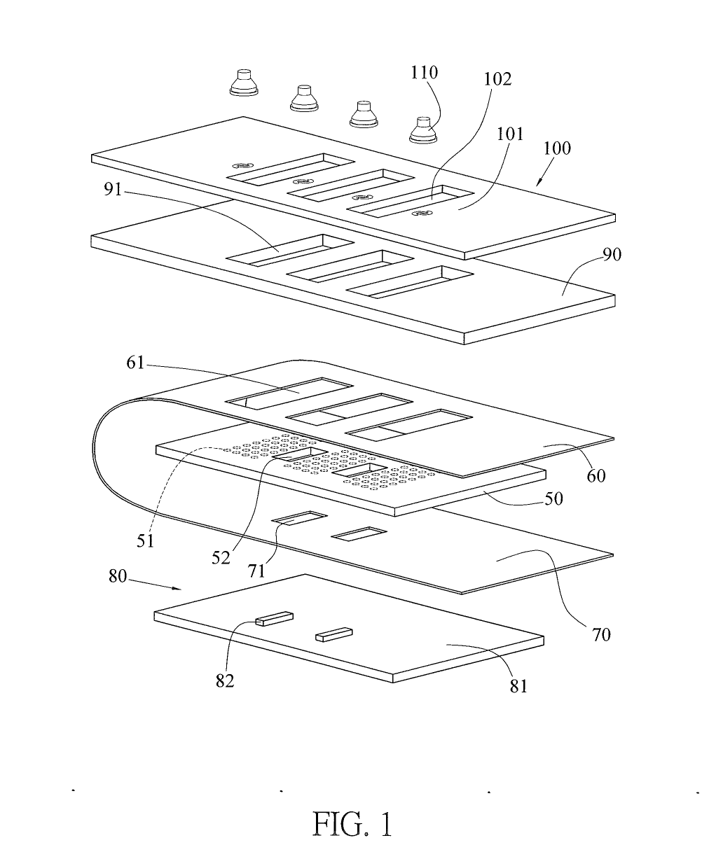

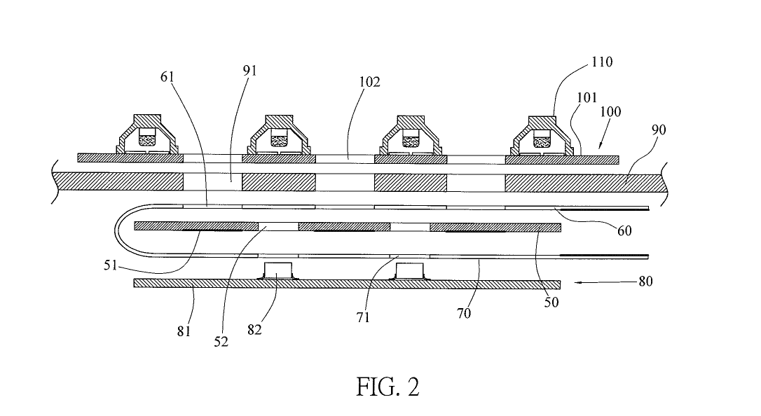

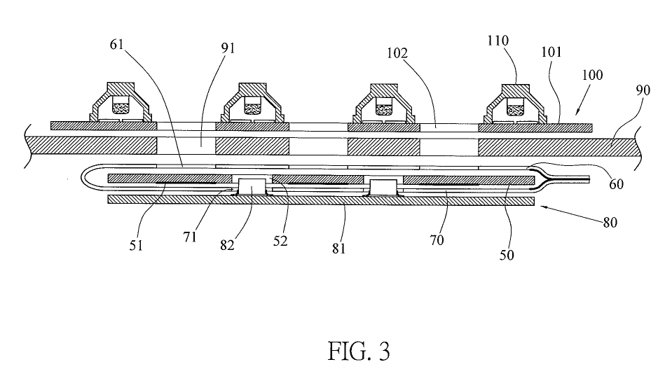

Referring to FIGS. 1 to 3, a backlight assembly in accordance with a first preferred embodiment of the invention comprises the following components as discussed in detail below.

A light guide plate 50, an upper reflective layer 60, and a lower reflective layer 70 are provided. The upper and lower reflective layers 60, 70 are unitary and folded along an intermediate portion of the unitary upper and lower reflective layers 60, 70 to contain the light guide plate 50. Further, ends of the unitary upper and lower reflective layers 60, 70 are adhesively secured together. The upper reflective layer 60 includes a plurality of openings 61. A light source 80 includes a light emitting circuit 81 and a plurality of light-emitting diodes (LEDs) 82 formed on the light emitting circuit 81. The light source 80 is provided under the lower reflective layer 70 (or the light guide plate 50). The lower reflective layer 70 includes a pluralilty of openings 71. The light guide plate 50 includes a pluralilty of openings 52. The LEDs 82 pass through the openings 71 to dispose in the openings 52. Thus, light emitted by the LEDs 82 may pass through the light guide plate 50. Further, the light transmits by means of the upper and lower reflective layers 60, 70. The components of the light source 80 are for description purposes only and are not subject of the invention.

A support plate 90 is provided above the upper reflective layer 60 and includes a plurality of openings 91. An opaque shading layer 100 is provided above the support plate 90 and includes a circuit 101 and a plurality of openings 102. The openings 102 and the circuit 101 are spaced apart. Top and/or bottom surface of the opaque shading layer 100 is coated with dark ink or formed with an opaque material. A plurality of elastic members 110 are provided on the circuit 101 respectively. A pressing of the elastic member 110 can short the corresponding circuit 101. The openings 61, 91, and 102 are aligned and communicate one another. Sizes of the openings 61, 91, and 102 are not required to be the same. Preferably, the support plate 90 is made of metal, and the upper and lower reflective layers 60, 70 are formed by folding an intermediate portion of a reflective layer and secured together at ends of the reflective layer with the light guide plate 50 disposed between the upper light guide plate 60 and the lower light guide plate 70. Both the upper and lower light guide plates 60, 70 are opaque. Each of the upper and lower light guide plates 60, 70 are white, silver, or gray. The light guide plate 50 further includes a plurality of reflective areas 51 formed on a bottom surface. The reflective areas 51 are aligned with the openings 61, 91, and 102. The reflective areas 51 can change direction of the light prior to passing through the openings 61, 91, and 102 to reach predetermined positions (e.g., bottom of keycaps of a keyboard or keypad) for illumination.

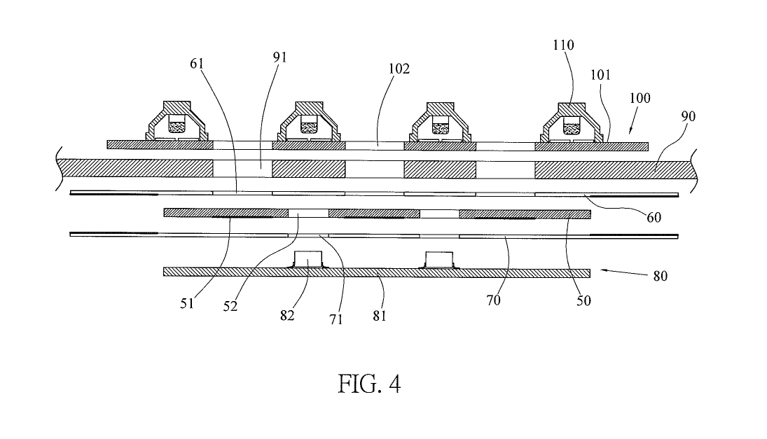

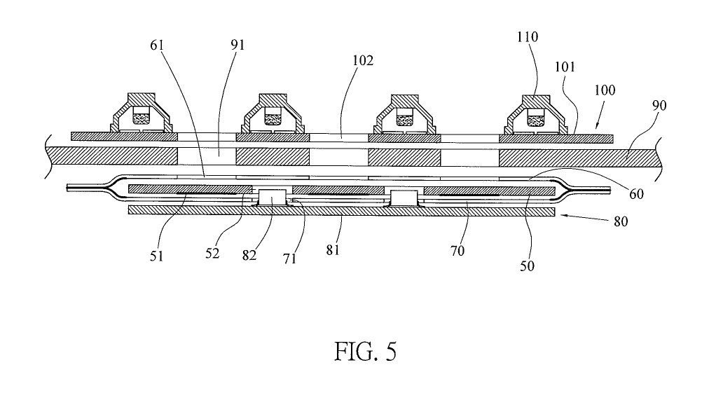

Referring to FIGS. 4 and 5, a backlight assembly in accordance with a second preferred embodiment of the invention is shown. The characteristics of the second preferred embodiment are substantially the same as that of the first preferred embodiment except the following:

The upper reflective layer 60 and the lower reflective layer 70 are unitary respectively. Two sides and two ends of the upper and lower reflective layers 60, 70 are adhesively secured together, and the light guide plate 50 is concealed by and between the upper and lower reflective layers 60, 70.

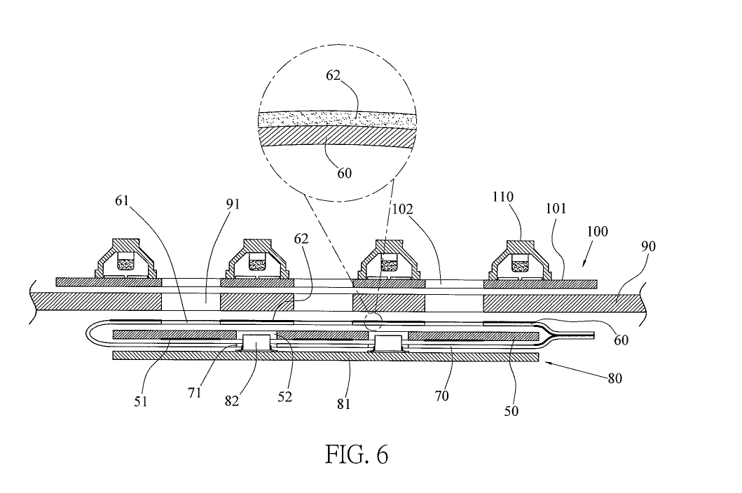

Referring to FIG. 6, a backlight assembly in accordance with a third preferred embodiment of the invention is shown. The characteristics of the third preferred embodiment are substantially the same as that of the first preferred embodiment except the following:

A portion or all of top surface of the upper reflective layer 60 is coated with ink 62.

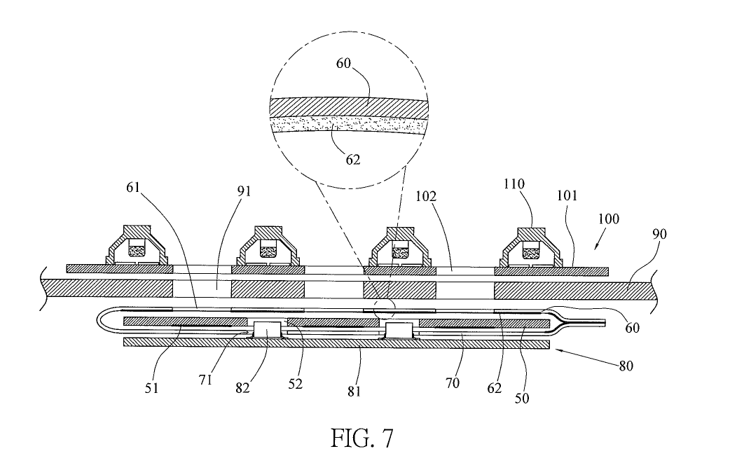

Referring to FIG. 7, a backlight assembly in accordance with a fourth preferred embodiment of the invention is shown. The characteristics of the fourth preferred embodiment are substantially the same as that of the third preferred embodiment except the following:

A portion or all of bottom surface of the upper reflective layer 60 is coated with ink 62.

It is envisage by the invention that the light guide plate 50 can direct light through the openings 61, 91, and 102 to reach predetermined positions (e.g., bottoms of keycaps of a keyboard or keypad) for illumination without being blocked by the conventional multi-layer structure. Therefore, energy loss is decreased to a minimum during light transmitting. Light with enhanced brightness is transmitted to the predetermined positions (i.e., bottom of keycaps of a keyboard or keypad) of a 3C product for illumination. Finally, the manufacturing cost is greatly decreased and energy is greatly saved.

While the invention has been described in terms of preferred embodiments, those skilled in the art will recognize that the invention can be practiced with modifications within the spirit and scope of the appended claims.

What is claimed is:

1. A backlight assembly comprising:
an upper reflective layer including a plurality of first openings;
a lower reflective layer secured to the upper reflective layer;
a light guide plate disposed between the upper and lower reflective layers; and
an opaque shading layer disposed on the upper reflective layer and including a circuit and a plurality of second openings;
wherein the first openings are aligned with the second openings and communicate therewith.

2. The backlight assembly of claim 1, wherein at least one surface of the opaque shading layer is coated with dark ink or formed with an opaque material.

3. The backlight assembly of claim 1, wherein the upper and lower reflective layer are unitary and folded to contain the light guide plate; wherein ends of the upper and lower reflective layers are adhesively secured together; and wherein the upper and lower reflective layers are opaque.

4. The backlight assembly of claim 1, wherein the upper reflective layer and the lower reflective layer are unitary respectively, edges of the upper and lower reflective layers are adhesively secured together, and the light guide plate is concealed by and between the upper and lower reflective layers.

5. The backlight assembly of claim 3, wherein each of the upper and lower light guide plates are white, silver, or gray.

6. The backlight assembly of claim 4, wherein each of the upper and lower light guide plates are white, silver, or gray.

7. The backlight assembly of claim 1, further comprising a support plate disposed between the upper reflective layer and the opaque shading layer, the support plate including a plurality of third openings, and wherein the first, second, and third openings are aligned and communicate one another.

8. The backlight assembly of claim 7, wherein sizes of the first, second, third openings are not required to be the same.

9. The backlight assembly of claim 1, further comprising a plurality of elastic members disposed on the circuit respectively, and wherein the second openings and the circuit are spaced apart.

10. The backlight assembly of claim 1, further comprising a light source disposed under the lower reflective layer, the light source includes a light emitting circuit and a plurality of light-emitting diodes (LEDs) formed on the light emitting circuit; wherein the lower reflective layer includes a plurality of fourth openings; and wherein the light guide plate includes a plurality of reflective areas for receiving the LEDs so that light emitted by the LEDs is configured to pass through the light guide plate and the light is further configured to transmitting by means of the upper and lower reflective layers.

11. The backlight assembly of claim 7, wherein the light guide plate includes a plurality of reflective areas formed on a bottom surface, the reflective areas being aligned with the first, second, and third openings so that the reflective areas are configured to change direction of the light prior to passing through the first, second, and third openings.

12. The backlight assembly of claim 1, wherein a portion or all of one surface of the upper reflective layer is coated with ink.
